(19) United States
(12) Patent Application Publication
(10) Pub. No.: US 2025/0100063 A1
(43) Pub. Date: Mar. 27, 2025

(54) APPARATUS FOR SORTING AND ALIGNING SHEAR STUDS FOR LOADING A SHEAR STUD FEEDER

(71) Applicant: Structural Services, Inc., Bethlehem, PA (US)

(72) Inventors: James T. Benzing, Bethlehem, PA (US); William R. Haller, Bethlehem, PA (US); Nicholas D. Caiazzo, Bath, PA (US); David W. Eckhart, II, Allentown, PA (US); Michael P. Kunz, Saylorsburg, PA (US); Glenn O'Rourke, Saylorsburg, PA (US)

(73) Assignee: Structural Services, Inc., Bethlehem, PA (US)

(21) Appl. No.: 18/896,797

(22) Filed: Sep. 25, 2024

Related U.S. Application Data
(60) Provisional application No. 63/674,020, filed on Jul. 22, 2024.
(60) Provisional application No. 63/540,244, filed on Sep. 25, 2023.

(51) Int. Cl. B23K 9/20; B23K 9/32

(52) U.S. Cl. CPC B23K 9/206; B23K 9/327

(57) ABSTRACT

An apparatus for sorting and aligning one or more shear studs for loading a shear stud feeder may include a lift mechanism having a lower lift member configured to lift shear studs from a hopper and deposit them onto an intermediate landing. An upper lift member may be configured to receive the shear studs from the intermediate landing and deposit them onto an upper landing. An alignment channel may be arranged downstream of the lift mechanism and configured to receive the shear studs from the upper landing and orient them with an elongated open slot of a magazine of the shear stud feeder. The alignment channel may include a slot configured for the shear studs to pass through and into the elongated open slot of the magazine.

### BACKGROUND

Certain modern construction applications require composite beams. A composite beam is typically a hot rolled steel beam that acts compositely with a concrete slab. In order to transfer force between the steel beam and the concrete slab, shear studs are welded to the steel, then concrete is poured over the beam, e.g., over a deck installed over the beam. The concrete hardens around the shear studs and engages the shear studs in a manner which allows the composite beam to become stiffer and more resistant to bending. This type of construction allows for longer spans and shallower floors when compared to non-composite building methods.

Typically, shear studs are manually welded onto a steel beam using a drawn arc stud welding process. In the drawn arc stud welding process, ceramic ferrules are placed at predetermined ground locations along the steel beam. One at a time, a shear stud is placed on the steel beam with the tip of the shear stud inside the ferrule. An electrical arc is transmitted from the stud welding gun through the shear stud and creates a pool of molten metal inside the ferrule from the tip of the shear stud. The ferrule keeps the molten metal therein and allows the end of the shear stud to be welded, or fused, to the surface of the steel beam.

The process of welding shear studs is very time consuming and arduous, and any improvements are welcome in the industry. For example, during the stud welding process, the operator of the stud welding gun must constantly manually load shear studs into the collet of the stud welding gun, one at a time. To address this, a shear stud feeder was developed. Exemplary embodiments of a shear stud feeder for a welding gun are disclosed and claimed in U.S. application Ser. No. 17/716,713, titled “Shear Stud Feeder for a Stud Welding Gun,” filed on Apr. 8, 2022, which is incorporated by reference as if fully set forth. Other exemplary embodiments of a shear stud feeder for a welding gun are disclosed in U.S. Provisional Patent Application No. 63/540,244, titled “Shear Stud Feeder for a Stud Welding Gun,” filed on Sep. 25, 2023, which is incorporated by reference as if fully set forth. The shear stud feeder quickly and efficiently delivers shear studs to the stud welding gun for loading therein. However, the shear stud feeder still must be manually loaded with shear studs by the operator, one at a time. Specifically, the operator must load shear studs into a magazine of the feeder such that each shear stud is suspended by its head with its body extending downwardly through an open slot of the magazine. Although the shear stud feeder eliminates the need for the operator to manually load each shear stud into the shear stud welding gun, it would further assist the operator to provide an apparatus that quickly and automatically sorts shear studs and loads them into the shear stud feeder to eliminate manual loading.

### SUMMARY

A method for sequentially loading a plurality of shear studs into a stud welding gun having a collet is disclosed. Each of the plurality of shear studs may include a head attached to a body, the head having a head diameter and the body having a body being cylindrical in shape and having a body diameter, the head diameter being greater than the body diameter. The method may include providing a hopper adapted to hold a plurality of shear studs that are randomly oriented, providing a feed slot having a feed slot width that is greater than the body diameter and less than the head diameter, the feed slot being angled downwardly from an upper end to the lower end, and providing a gate assembly located at the lower end of the feed slot that is adapted to releasably retain one of the plurality of shear studs at a time and to enable the collet to engage the retained shear stud when the collet is placed above the head of the retained shear stud. The method may further include transporting the plurality of shear studs from the hopper to the feed slot in a manner that results in the head of each of the transported shear studs resting atop the feed slot and the body of each of the transported shear studs freely hanging downward vertically from the feed slot, and releasing the transported shear studs from the feed slot to the gate assembly one at a time.

A system for sequentially loading a plurality of shear studs into a stud welding gun having a collet is also disclosed. Each of the plurality of shear studs may include a head attached to a body, the head having a head diameter and the body having a body being cylindrical in shape and having a body diameter, the head diameter being greater than the body diameter. The system may include a magazine, which may include a feed slot having a feed slot axis and feed slot width that is greater than the body diameter and less than the head diameter. The feed slot may be angled downwardly from an upper end to the lower end. A gate assembly may be located at the lower end, the gate assembly being adapted to releasably retain one of the plurality of shear studs at a time and to enable the collet to engage the retained shear stud when the collet is placed above the head of the retained shear stud. An advancing mechanism may be adapted to release the plurality of shear studs from the magazine to the gate assembly.

The shear stud feeder described herein includes several improvements including the ability to feed shear studs one at a time to a gate mechanism from a hopper in which the shear studs are randomly oriented. This simplifies the loading of shear studs into the shear stud feeder and reduces the labor required to load and reload. In addition, the shear stud feeder also orients the feed slot (and therefore the gate assembly) which reduces the amount of body twisting required to move a welding gun from the gate assembly to weld locations on a beam. This improves efficiency and reduces body strain on the operator.

Other aspects, features and advantages of the present invention will become apparent from the following detailed description taken in conjunction with the accompanying drawings.

### BRIEF DESCRIPTION OF THE DRAWINGS

For a more complete understanding of the present invention, reference is made to the following detailed description of implementations considered in conjunction with the accompanying drawings, in which:

FIG. 1 is a perspective view of an apparatus for sorting and aligning shear studs for loading a shear stud feeder according to an implementation;

FIG. 2 is another perspective view of the apparatus for sorting and aligning shear studs for loading a shear stud feeder according to an implementation;

FIG. 3 is another perspective view of the apparatus for sorting and aligning shear studs for loading a shear stud feeder according to an implementation;

FIG. 4A is a perspective detailed view illustrating operation of the lift mechanism of the inventive apparatus according to an implementation;

FIG. 4B is another perspective detailed view illustrating operation of the lift mechanism of the inventive apparatus according to an implementation;

FIG. 4C is another perspective detailed view illustrating operation of the lift mechanism of the inventive apparatus according to an implementation;

FIG. 4D is another perspective detailed view illustrating operation of the lift mechanism of the inventive apparatus according to an implementation;

FIG. 4E is another perspective detailed view illustrating operation of the lift mechanism of the inventive apparatus according to an implementation;

FIG. 4F is another perspective detailed view illustrating operation of the lift mechanism of the inventive apparatus according to an implementation;

FIG. 5A is a perspective detailed view illustrating operation of the alignment channel of the inventive apparatus according to an implementation;

FIG. 5B is another perspective detailed view illustrating operation of the alignment channel of the inventive apparatus according to an implementation;

FIG. 5C is another perspective detailed view illustrating operation of the alignment channel of the inventive apparatus according to an implementation;

FIG. 6 is a schematic diagram illustrating circuitry for operation of the lift mechanism of the inventive apparatus according to an implementation;

FIG. 7 is a perspective view of a shear stud welding gun according to an implementation; and

FIG. 8, is a flowchart showing exemplary functional steps involved in the operation of an illustrative implementation of a shear stud feeder.

### DETAILED DESCRIPTION

The following disclosure is presented to provide an illustration of the general principles of the present invention and is not meant to limit, in any way, the inventive concepts contained herein. Moreover, the particular features described in this section can be used in combination with the other described features in each of the multitude of possible permutations and combinations contained herein.

All terms defined herein should be afforded their broadest possible interpretation, including any implied meanings as dictated by a reading of the specification as well as any words that a person having skill in the art and/or a dictionary, treatise, or similar authority would assign particular meaning. Further, it should be noted that, as recited in the specification and in the claims appended hereto, the singular forms “a,” “an,” and “the” include the plural referents unless otherwise stated. Additionally, the terms “comprises” and “comprising” when used herein specify that certain features are present in that implementation but should not be interpreted to preclude the presence or addition of additional features, components, operations, and/or groups thereof.

The following disclosure is intended to be read in connection with the accompanying drawings, which are to be considered part of the entire written description of the invention. The drawing figures are not necessarily to scale and certain features of the invention may be shown exaggerated in scale or in somewhat schematic form in the interest of clarity and conciseness. In this description, relative terms such as “horizontal,” “vertical,” “up,” “down,” “top,” “bottom,” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “extension” versus “retraction,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both moveable or rigid attachments or relationships, unless expressly described otherwise, and includes terms such as “directly” coupled, secured, etc. The term “operatively coupled” is such an attachment, coupling, or connection that allows the pertinent structures to operate as intended by virtue of that relationship.

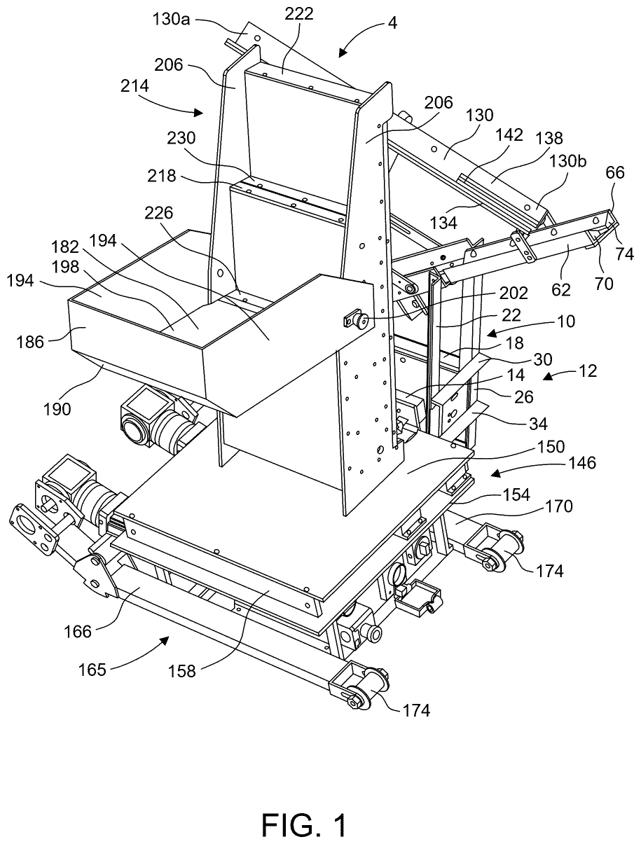

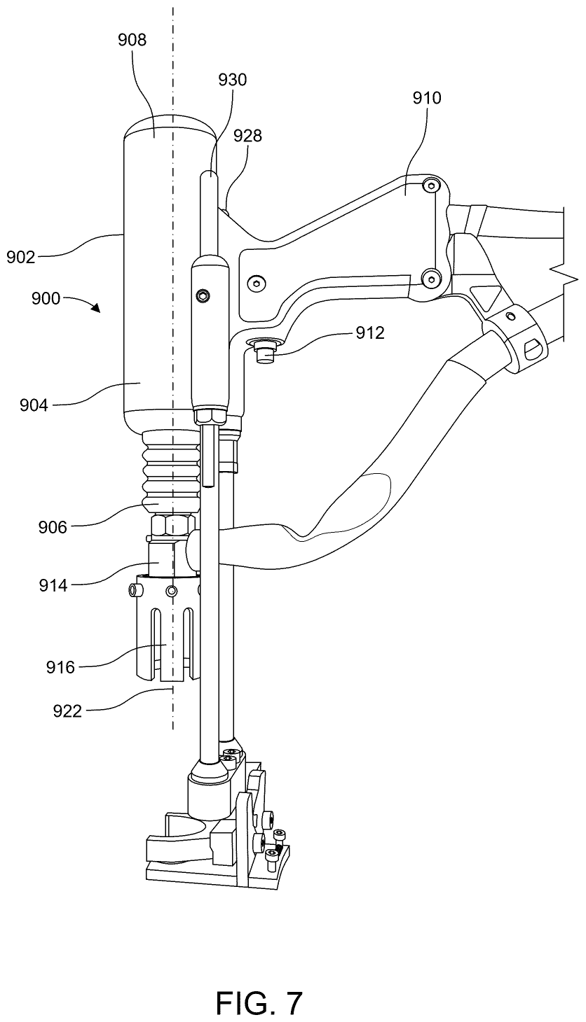

Referring initially to FIGS. 1-3, an illustrative implementation of a shear stud feeder 10 is shown. As shown, the shear stud feeder 10 may include four main components including a hopper 182, a lift mechanism 214, an alignment channel 130, and a motorized conveyor cart 146. During use, and as explained in greater detail below, a worker can utilize the shear stud feeder 10 to sort and align shear studs for loading a shear stud feeder 10. Once loaded, the worker can use a shear stud welding gun (shown in FIG. 7) to retrieve shear studs 176 from the shear stud feeder 10 and weld each shear stud 176 to a steel plate, e.g., the upper flange of a steel I-beam.

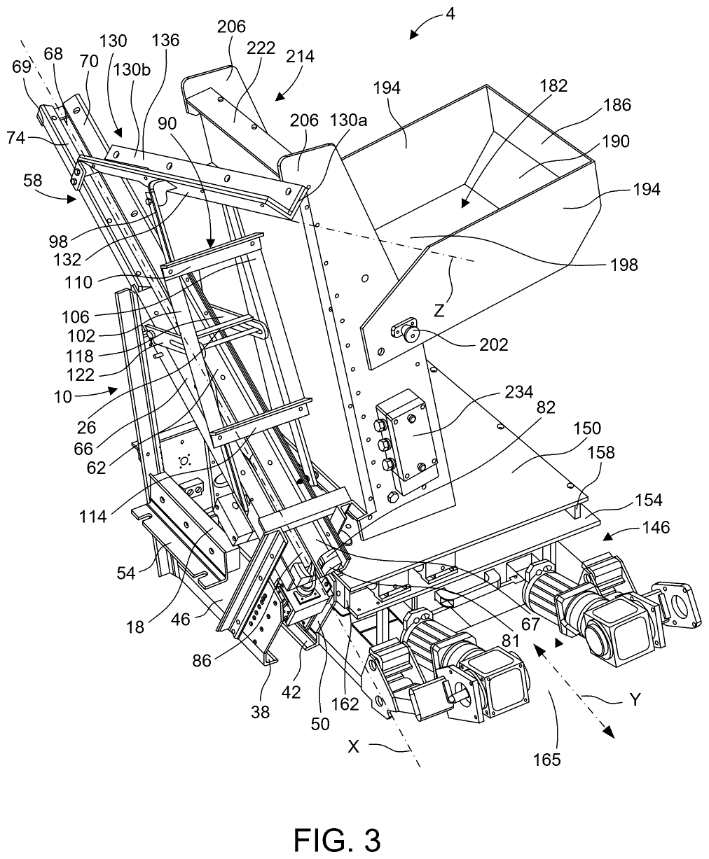

FIGS. 1 through 3 illustrate an exemplary shear stud feeder 10. As depicted, the shear stud feeder 10 may include a support frame 12 for supporting a magazine 58 at a predetermined angle relative to horizontal. The magazine 58 includes a length and a longitudinal axis X (see FIG. 3). The support frame 12 may include generally horizontal inner and outer bottom rails 42, 38. The bottom rails 42, 38 may be steel channels, each having a generally L-shaped cross section. The bottom rails 42, 38 may be spaced apart from one another and extend in a direction that may be substantially parallel to one another. The support frame 12 may also include inner and outer steel plates 50, 46 that may be attached to the outer and inner bottom rails 42 by bolting, welding, or any other suitable means for attachment. The support frame 12 may also include vertically oriented inner and outer rear legs 22, 26, that are substantially parallel and separated from one another. The rear legs 22, 26 extend upwardly to support the magazine 58. The support frame 12 may also include inner and outer side braces 14, 18, that are horizontally oriented and extend in a forward direction from the rear legs 22, 26. The support frame 12 may also include horizontally oriented lower and upper rear braces 34 and 30 extending between the rear legs 22, 26 to provide rigidity to the rear legs 22, 26. An angled support plate 54 may be attached to the outer side brace 18 to add further rigidity to the support frame 12.

The shear studs 176 may be fed into the magazine 58 of the feeder 10 using the apparatus 4. As shown in FIGS. 1 through 3, and 4A through 4F, the apparatus 4 includes a hopper 182 configured to accommodate a large number of shear studs 176. The hopper 182 has a rectangular box-like shape as viewed in FIGS. 1 through 3 and includes a rectangular outer wall plate 186, a rectangular inclined plate 190, and a rectangular floor plate 198 that extend between opposed side wall plates 194 that are spaced apart and generally rectangular in shape. These plates may be formed of any suitable material, such as aluminum or stainless steel, and may be joined together by any suitable means, e.g., welding, to form the hopper 182. The inclined plate 190 extends from the bottom of the outer wall plate 186 to the floor plate 198, and the hopper 182 is shown as being hingedly connected to a lift mechanism 214 at pins 202 that extend through aligned openings in the side wall plates 194 and in vertical support walls 206 of the lift mechanism 214. In this manner, the hopper 182 may be tilted from a horizontal position to an inclined position at pins 202 which will cause the shear studs 176 to travel down the inclined plate 190, along the floor plate 198, and towards the lift mechanism 214 for sorting and loading.

The hopper 182 is configured to store a large number of shear studs 176 such that each shear stud 176 may be in a random orientation within the hopper 182. In other words, a large number of shear studs 176 may be simultaneously placed into the hopper 182 without regard to their position or orientation. In other shear stud loader implementations, the operator is required to load shear studs into a magazine of the feeder and then secure the magazine to the shear stud loader prior to operation thereof. In an implantation of the present invention, the hopper 182 eliminates the need for the operator to manually load the magazine 58 with shear studs 176, which improves the efficiency of the stud loading process and reduces manual labor for the improved comfort of the operator. As described herein, when the hopper 182 is tilted at pins 202, the shear studs 176 travel towards the lift mechanism 214 for automated sorting and loading. As discussed below, the shear studs 176 automatically align in the desired orientation within the magazine 58, assisting the operator by quickly and automatically sorting shear studs while automatically loading them into the shear stud feeder to eliminate manual loading. In other words, the lift mechanism 214 also functions as a sorting mechanism (described in detail below), which is adapted to transport the plurality of studs 176 to the feed slot 68 and align the transported studs so that the head 180 of each of the transported shear studs rests atop the feed slot 68 and the body 184 of each of the transported shear studs 176 hangs downward vertically from the feed slot 68.

As shown, the magazine 58 may include an inner slide rail 62 that may include a raised end and a lowered end. At or near its raised end, the inner slide rail 62 may be connected, or otherwise coupled, to a location at, or near, the upper end of the inner rear leg 22. At or near its lower end, the inner slide rail 62 may be connected, or otherwise coupled, to the inner steel plate 50. As shown, the inner slide rail 62 may form an angle A1 with respect to a horizontal axis and A1 may be greater than or equal to 10°, such as greater than or equal to 15°, greater than or equal to 20°, greater than or equal to 25°, or greater than or equal to 30°. In another aspect, A1 may be less than or equal to 45°, such as less than or equal to 40°, or less than or equal to 35°. It is to be understood that A1 may be within a range between, and including, any of the minimum or maximum values of A1 described herein.

In a particular aspect, the inner slide rail 62 may include a layer of polymer disposed thereon. The layer of polymer may have a low friction, a high resistance to abrasion, and a high durability. The polymer may be polytetrafluoroethylene (PTFE), polyoxymethylene (POM), ultra-high molecular weight polyethylene (UHMW), high-density polyethylene (HDPE), or a combination thereof. This polymer layer may facilitate shear studs sliding thereon.

As shown, the magazine 58 may also include an outer slide rail 66, similar to the inner slide rail 62, that may include an elevated end and a lowered end. At or near its elevated end, the outer slide rail 66 may be connected, or otherwise coupled, to a location at, or near, the upper end of the outer rear leg 26. At or near its lower end, the outer slide rail 66 may be connected, or otherwise coupled, to the outer steel plate 46. It is to be understood that the outer slide rail 66 may form an angle with respect to horizontal within the range A1 described above.

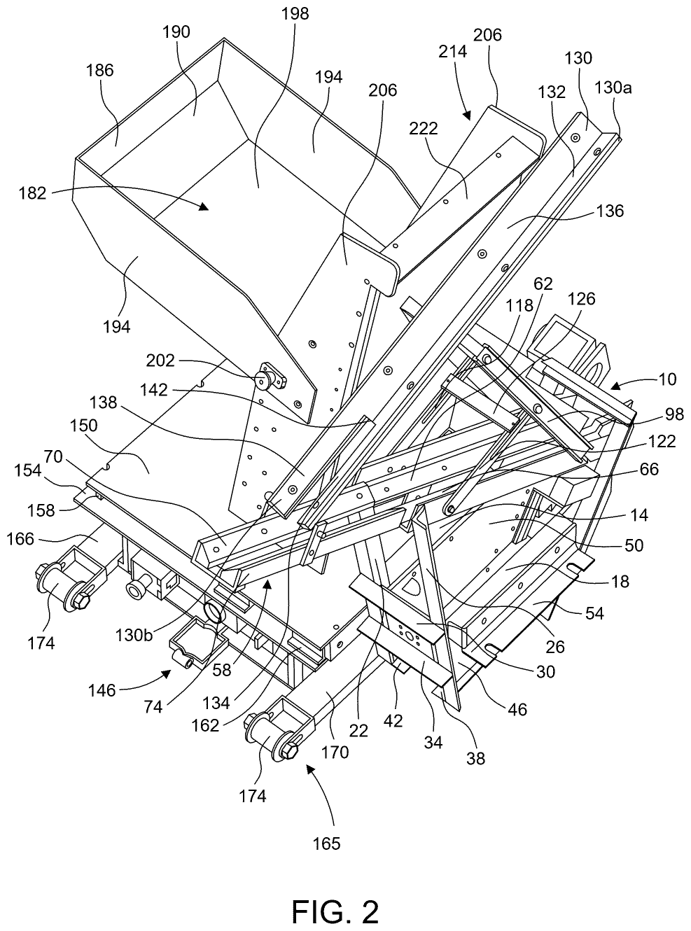

As best shown in FIGS. 2 and 3, the inner slide rail 62 may be spaced apart from the outer slide rail 66 having a width, W1, to form a feed slot 68, or channel, between the slide rails 62, 66 along the lengths of the slide rails 62, 66. The feed slot 68 receives and supports each shear stud 176 by its head portion 180. The head portion 180 of each shear stud 176 includes a diameter that is greater than a diameter of each body portion 184. The body portion 184 of each shear stud 176 may also be cylindrical in shape. The feed slot 68 therefore must be wide enough to allow the body 184 of the shear stud 176 to extend therethrough, yet narrow enough to retain the head portion 180 of each shear stud 176 and prevent the head portion 180 from falling through the feed slot 68.

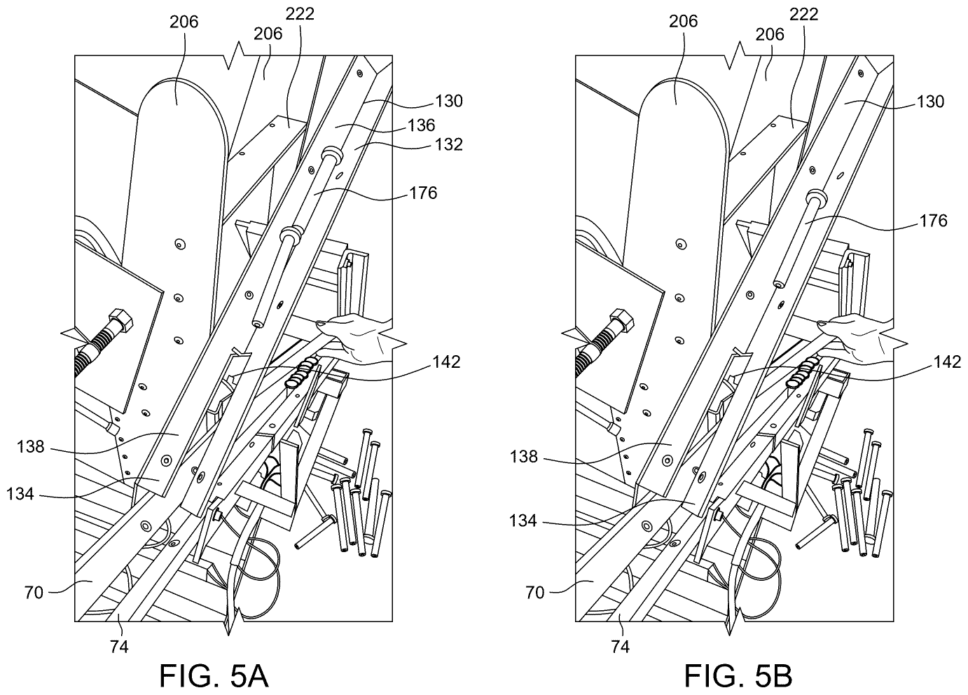

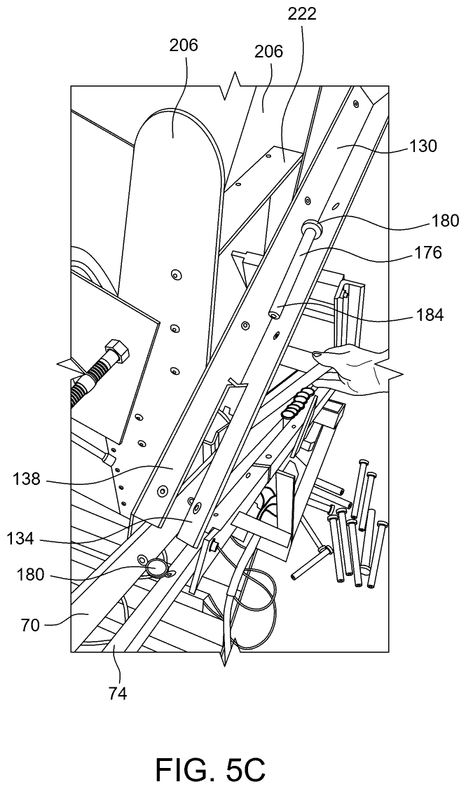

In a particular aspect, W1 is slightly greater than the diameter, d, of the body 184 of a shear stud 176 (FIGS. 5A through 5C). In particular, W1 may be greater than or equal to 1.01*d, such as greater than or equal to 1.02*d, greater than or equal to 1.03*d, greater than or equal to 1.04*d, or greater than or equal to 1.05*d. In another aspect, W1 may be less than or equal to 1.10*d, such as less than or equal to 1.09*d, less than or equal to 1.08*d, less than or equal to 1.07*d, or less than or equal to 1.06*d. It is to be understood that W1 may be within a range between, and including, any of the minimum and maximum values of W1 described herein. In any case, W1 cannot be greater than the diameter of the head portion 180 to suspend the shear studs 176 within the feed slot 68 by the head portion 180 of each shear stud 176, so that the body 184 of each shear stud 176 hangs below the bottom of the magazine 58. Together, the spaced apart inner slide rail 62 and outer slide rail 66 form the magazine 58 having the length along the longitudinal axis.

In a particular aspect, the outer slide rail 66 may include a layer of polymer disposed thereon. The layer of polymer may have a low friction, a high resistance to abrasion, and a high durability. The polymer may be polytetrafluoroethylene (PTFE), polyoxymethylene (POM), ultra-high molecular weight polyethylene (UHMW), high-density polyethylene (HDPE), or a combination thereof. This polymer layer may facilitate shear studs sliding thereon.

The inner slide rail 62 may be provided with a shoulder segment 70 that extends over a portion of the length of the inner slide rail 62 at its elevated end. Similarly, the outer slide rail 66 may be provided with a shoulder segment 74 that extends over a portion of its length at its elevated end. As best shown in FIG. 1, each shoulder segment 70, 74 includes a surface that slopes towards the feed slot 68 to channel the shear studs 176 received from the alignment channel 130 into the feed slot 68 of the magazine 58. As best shown in FIG. 3, the feed slot 68 includes a feed slot axis Y along which the feed slot 68 is oriented from an upper end 69 to a lower end 67. The feed slot 68 is angled downwardly from an upper end 69 to a lower end 67 to facilitate shear studs 176 sliding down the feed slot 68 due to gravity. The shoulder segments 70, 74 may include a polymer layer as discussed above to facilitate shear studs sliding thereon.

When loaded by the apparatus 4, the magazine 58 may include a plurality of shear studs 176 suspended therein as described above. Retaining the magazine 58 at such a sufficient angle A1 and optionally applying a layer of a suitable polymer to the inside surface of the inner and outer slide rails 62, 66, and the shoulder segments 70, 74 will facilitate sliding of the shear studs 176 out of the magazine 58 when desired.

Referring now to FIG. 7, a shear stud welding gun is illustrated and is generally designated 900. The shear stud welding gun 900 may include a body 902. The body 902 may include a barrel 904 that may include a lower end 906 and an upper end 908. A handle 910 may extend from the barrel 904 near the upper end 908 of the barrel 904. The handle 910 may include a button 912 that an operator may press, or otherwise toggle, to initiate an arc to perform a welding operation using the shear stud welding gun 900.

A collet 914 may extend from the lower end 906 of the barrel 904 of the shear stud welding gun 900 and a spark shield 916 may at least partially circumscribe, or surround, a portion of the collet 914, e.g., the end of the collet 914 that is configured to receive and engage the head of a shear stud (not shown in FIG. 7). When fully engaged, the shear stud 176 may intrude approximately ¼″ into the end of the collet 914, which may correspond to approximately the thickness of the head of an exemplary shear stud 176.

Referring now to FIG. 3, the shear stud feeder 10 may include a gate assembly 81 including an inner gate 82 and an outer gate 86 positioned adjacent to the lowered ends of the slide rails 62, 66. The inner and outer gates 82, 86 are biased to a closed position and may be rotatably disposed to move from the closed position to an open position. In the closed position, one or more shear studs 176 may be held in place within the magazine 58 where they are available for retrieval by a stud welding gun, e.g., the collet 914 of the stud welding gun 900 shown in FIG. 7, for example.

During operation, a worker may place the collet of a shear stud welding gun over the head portion 180 of the shear stud 176 that is hanging adjacent the inner and outer gates 82, 86. Using the welding gun, the worker may push downwardly to open the inner and outer gates 82, 86 and force the head portion 180 of the shear stud 176 into the collet of the welding gun. As the worker removes the shear stud 176 from the open gates 82, 86, the gates are caused to close and the next shear stud 176 is caused to travel towards the closed gates 82, 86 where it may be held in place within the magazine 58 until retrieval by the stud welding gun. In other words, the gate assembly 81 is adapted to releasably retain one of the plurality of shear studs 176 at a time and to enable the collet to engage the retained shear stud 176 when the collet is placed above the head 180 of the retained shear stud 176. The shear stud feeder 10 may include an advancing mechanism adapted to release the plurality of shear studs 176, one a time, from the magazine 58 to the gate assembly 81. On example advancing mechanism may include a stud sprocket with a plurality of sprocket teeth, whereby individual shear studs 176 may fit, one at a time, between adjacent sprocket teeth of the stud sprocket as the stud sprocket rotates, which feeds the shear studs 176, to the gate assembly 81 from the magazine 58. An example of such an advancing mechanism is designated as a feed mechanism and is shown and described in detail in U.S. Patent Application Publication No. US20220324050A1, which is incorporated by reference as if fully set forth. In other implementations, other types of advancing mechanisms may be used. In this way, the shear stud feeder 10 may continuously provide shear studs 176 to a shear stud welding gun—as long as there are shear studs 176 placed in the magazine 58. The shear stud feeder 10 eliminates the need for the worker to manually load each shear stud 176 into the shear stud welding gun.

In one implementation, the shear stud feeder 10 further includes a mechanism which causes the released shear stud 176 located in the gate assembly 81 to be driven upwardly into the collet when the collet is positioned above the head of the released shear stud. In one implementation, the mechanism may be a retractable hammer that drives the shear stud 176 upwardly into the collet. In one implementation, the released shear stud 176 located in the gate assembly 81 is driven upwardly into the collet when the collet is positioned above the head of the released shear stud 176 in response to a user-activated switch. The user activated switch may be located directly on the shear stud welding gun.

Exemplary retractable hammer assemblies and other mechanisms for driving the shear stud 176 upwardly into the collet are shown and described in detail in U.S. Patent Application Publication No. US20220324050A1, which is incorporated by reference as if fully set forth.

For example, a hammer assembly may be positioned below or within the gate assembly. The hammer assembly may include a hammer rod that is operably connected to a compressed air cylinder or a solenoid. When activated, the compressed air cylinder or solenoid causes the hammer rod to move upwardly, which exerts a force on the lower end of the shear stud that is supported in the gate assembly. This drives the head of the shear stud into a collet of a welding gun that is positioned above the gate assembly.

The shear studs 176 may be fed into the magazine 58 of the feeder 10, via a feed slot 68 of the magazine 58, using the apparatus 4. As shown in FIGS. 1 through 3, and 4A through 4F, the apparatus 4 includes a hopper 182 configured to accommodate a large number of shear studs 176. The hopper 182 has a rectangular box-like shape as viewed in FIGS. 1 through 3 and includes a rectangular outer wall plate 186, a rectangular inclined plate 190, and a rectangular floor plate 198 that extend between opposed side wall plates 194 that are spaced apart and generally rectangular in shape. These plates may be formed of any suitable material, such as aluminum or stainless steel, and may be joined together by any suitable means, e.g., welding, to form the hopper 182. The inclined plate 190 extends from the bottom of the outer wall plate 186 to the floor plate 198, and the hopper 182 is shown as being hingedly connected to a lift mechanism 214 at pins 202 that extend through aligned openings in the side wall plates 194 and in vertical support walls 206 of the lift mechanism 214. In this manner, the hopper 182 may be tilted at pins 202 which will cause the shear studs 176 to travel down the inclined plate 190, along the floor plate 198, and towards the lift mechanism 214 for sorting and loading.

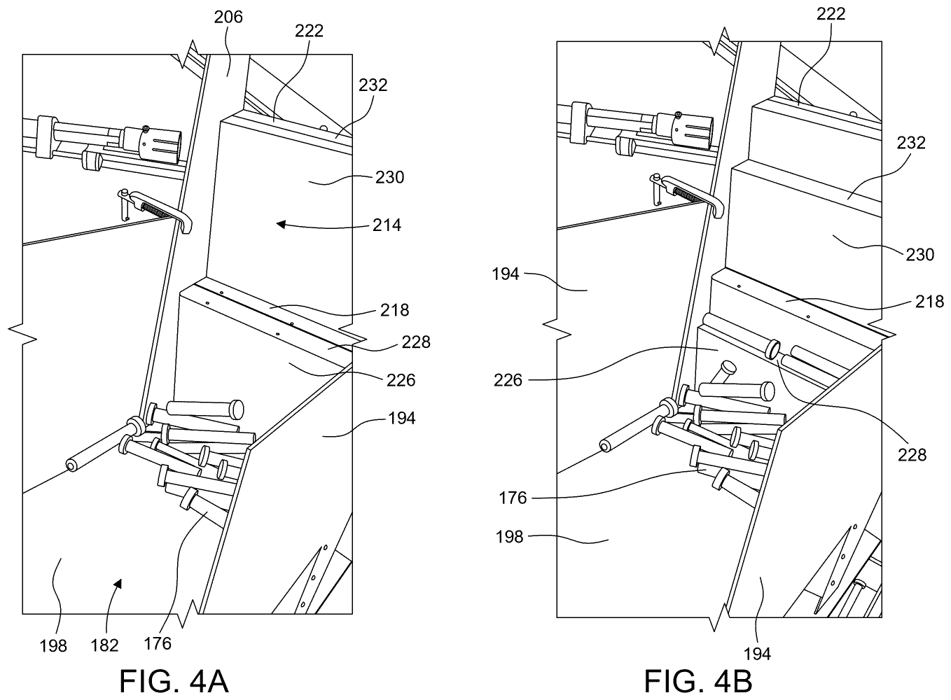

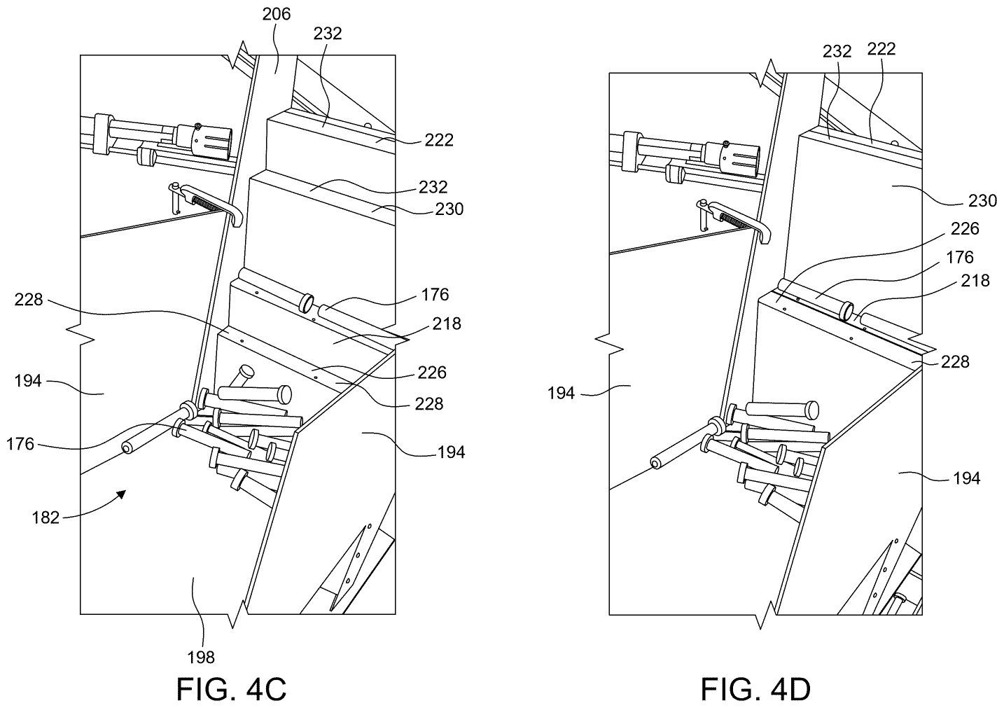

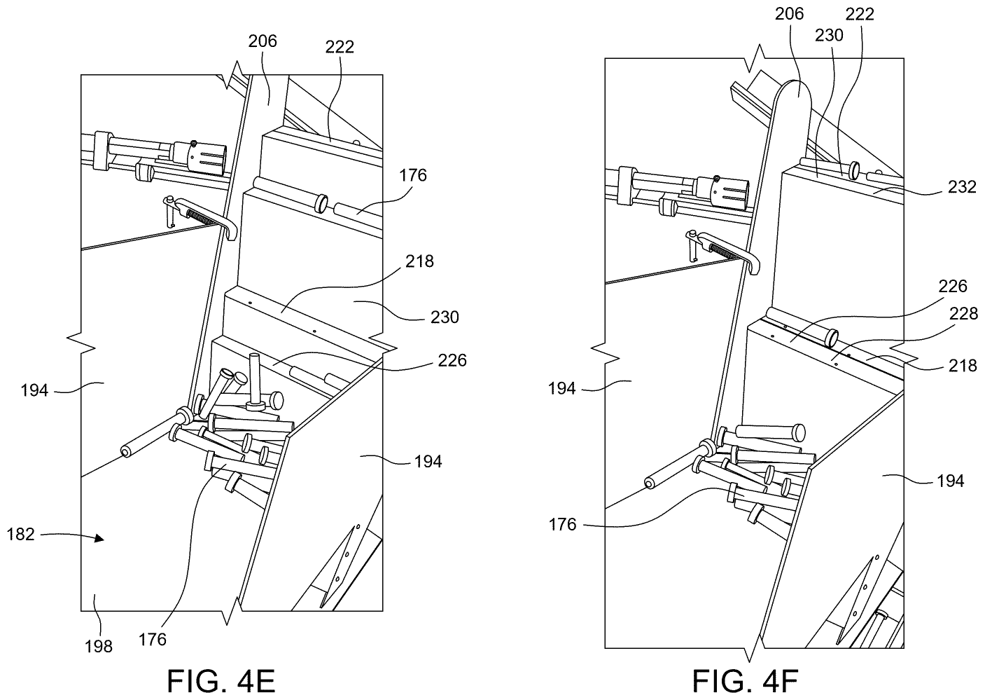

As best shown in FIGS. 4A through 4F, the lift mechanism 214 includes a lower lift member 226 having a horizontal placement surface 228, an intermediate landing 218, an upper lift member 230 having a horizontal placement surface 232, and an upper landing 222. The components of the lift mechanism 214 may be made of any suitable material, e.g., aluminum or stainless steel. The lower lift member 226 is formed of a thick plate material into a rectangular shape that extends between the vertical support walls 206 such that there are slight gaps between the outer surfaces of the lower lift member 226 and the vertical support walls 206. The lower lift member 226 is motor driven to move in an approximately vertical direction between a lowered position and a raised position. In the lowered position, the placement surface 228 of the lower lift member 226 is even with and adjacent the floor plate 198 of the hopper 182 to enable one or more shear studs 176 to transfer, e.g., roll or slide, from the floor plate 198 onto the placement surface 228. The number of shear studs 176 to be placed onto the placement surface 228 is determined based upon the length and width of the placement surface 228. In the illustrated case, the number of shear studs to be placed is one or two. In other embodiments, the number of shear studs could be greater. As the lower lift member 226 moves from the lowered position to the raised position, the one or more shear studs 176 is carried thereon towards the intermediate landing 218 (FIG. 4B). Once the lower lift member 226 reaches the raised position, the placement surface 228 of the lower lift member 226 becomes even with and adjacent to the intermediate landing 218. The placement surface 228 may be sloped slightly towards the intermediate landing 218 such that any shear studs 176 positioned on the placement surface 228 will transfer, e.g., roll or slide, onto the intermediate landing 218 (FIG. 4D) where they are retained until further transport by the upper lift member 230. Thereafter, the lower lift member moves from the raised position to the lowered position (FIG. 4C) to retrieve additional shear studs 176 disposed within the hopper 182 for sorting and loading into the shear stud feeder 10.

Likewise, the upper lift member 230 is formed of a thick plate material into a rectangular shape that extends between the vertical support walls 206 such that there are slight gaps between the outer surfaces of the upper lift member 230 and the vertical support walls 206. The upper lift member 230 is motor driven to move in an approximately vertical direction between a lowered position and a raised position. The upper lift member 230 may be arranged to move between its lowered and raised positions simultaneously with movement of the lower lift member 226 between these positions. In the lowered position, the placement surface 232 of the upper lift member 230 is even with and adjacent the intermediate landing 218 to cause any shear studs 176 positioned on the intermediate landing 218 to transfer, e.g., roll or slide, therefrom onto the placement surface 232 of the upper lift member 230 (FIG. 4D). The number of shear studs 176 to be placed onto the placement surface 232 is determined based upon the length and width of the placement surface 232. In the illustrated case, the number of shear studs to be placed is one or two. In other embodiments, the number of shear studs could be greater. As the upper lift member 230 moves from the lowered position to the raised position, the one or more shear studs 176 are carried thereon towards the upper landing 222. Once the upper lift member 230 reaches the raised position, the placement surface 232 of the upper lift member 230 becomes even with and is positioned adjacent to the upper landing 222. The placement surface 232 may be sloped slightly towards the upper landing 222 such that any shear studs positioned of the placement surface 232 will transfer, e.g., roll or slide onto the upper landing 222 (FIGS. 4E and 4F). A motor and gear box (not shown) could be provided to drive the lower and upper lift members 226 between the lowered and raised positions. The motor, which may be a brushless DC motor, is controlled by a control unit 234. FIG. 4 is a schematic diagram illustrating the motor-driven operation of the lower and upper lift members 226, 230.

Referring now to FIGS. 5A through 5C, upon reaching the upper landing 222, the shear studs 176 may transfer, e.g., roll or slide, onto an alignment channel 130. As depicted in FIGS. 2 and 3, the alignment channel 130 may be supported by a support framework 90 which may include inner and outer parallel support rails 98, inner and outer parallel reinforcement members 102, 106, upper and lower parallel reinforcement member 110, 114, inner and outer support braces 118, 122, and a cross support brace 126.

As shown, the alignment channel 130 includes a raised end 130a and a length that extends along a longitudinal axis from the raised end 130a to a lowered end 130b. The alignment channel 130 is inclined at a predetermined angle relative to horizontal, e.g., within the range A1 described above. As shown in FIG. 3, the alignment channel 130 is positioned over the magazine 58 of the shear stud feeder 10 such that the longitudinal axis Z of the alignment channel 130 and the longitudinal axis X of the magazine 58 share a common vertical plane. In this manner, shear studs 176 may descend, e.g., slide, down the alignment channel 130, either head first or shaft first, and fall through a slot 142 of the alignment channel 130 in an orientation where they will be suspended within the magazine 58 by the head portion 180 with the body 184 extending through the feed slot 68, ready for retrieval. In this way, the shear studs 176 are transported from the hopper 182 in a manner that results in the head 180 of each of the transported shear studs 176 resting atop the feed slot 68 and the body 184 of each of the transported shear studs 176 hanging downward vertically from the feed slot 68.

The alignment channel 130 includes an inner wall 132 and an outer wall 136, which together provide a V-shaped cross section to prevent the shear studs 176 from falling off the alignment channel 130. Optionally, a layer of a suitable polymer may be applied to the top surfaces of the inner and outer walls 132, 136 to facilitate sliding of the shear studs 176 from the raised end towards the lowered end. The slot 142 of the alignment channel 130 is formed between an inner leg 134 and an outer leg 138, and may include a width, W2, that is slightly greater than the diameter of the head portion 180 of the shear stud 176. The slot 142 of the alignment channel is configured for shear studs 176 to pass therethrough and into the feed slot 68.

Referring now to FIGS. 1-3, the apparatus 4 and shear stud feeder 10 may be supported on a motorized conveyor cart 146 which allows the operator to reposition the apparatus 4 and the shear stud feeder 10 without manual effort. The motorized conveyor cart 146 may include a platform comprising an upper mounting plate 150 and a lower plate 154 mounted to inner and outer support rails 158, 162. The magazine 58, the gate assembly 81, and other components of the shear stud feeder 10, including an advancing mechanism (described below), are mounted to the platform 150. As shown in FIG. 3, the platform 150 may have a platform longitudinal axis Y that is substantially parallel to the feed slot axis X. In this context, “substantially parallel” should be understood to mean that the angle feed slot axis X and the platform longitudinal axis Y is within a range of plus or minus 15 degrees. This substantially parallel orientation enables the operator to substantially reduce the body rotation required to move the welding gun from engaging a stud retained in the gate assembly 81 to position the stud in a welding position on a beam.

The motorized conveyor cart 146 may include a motorized drive assembly 165 having an outer drive system 166 which engages an inner drive system 170. The outer drive system 166 is capable of acting independently of the inner drive system 170 for the purpose of allowing the cart 146 to rotate in a clockwise and counterclockwise manner with respect to a vertical axis as deemed necessary by the operator while moving over corrugated deck pans, a surface of a bridge, or any other supporting surface. The outer drive system 166 may be located on a first side of the motorized conveyor cart 146 and may include rollers or tracks 174, which may be made of rubber or any other suitable material. The inner drive system 170 may be located on a second side of the motorized conveyor cart 146 and may be similar to the outer drive system 166. The inner drive system 170 may include rollers or tracks 174 which may be made of rubber or any other suitable material. The tracks 174 of the inner drive system 170 may be oriented parallel to the tracks 174 of the outer drive system 168.

As mentioned above, one benefit of the shown implementation is that, in the case where the motorized conveyor cart 146 moves in a linear direction along the platform longitudinal axis Y, the shear stud feeder 10 is also aligned substantially parallel to the beam (not shown) to which the shear studs are being welded. In other shear stud loader implementations, the operator is required to rotate, sometimes at least ninety degrees, after loading a welding gun with a shear stud to turn and face the steel beam to be in the correct position for welding the shear stud to the beam. In the shown implementation, the operator does not have to reposition after loading the welding gun, improving operating comfort and overall efficiency of the stud welding process.

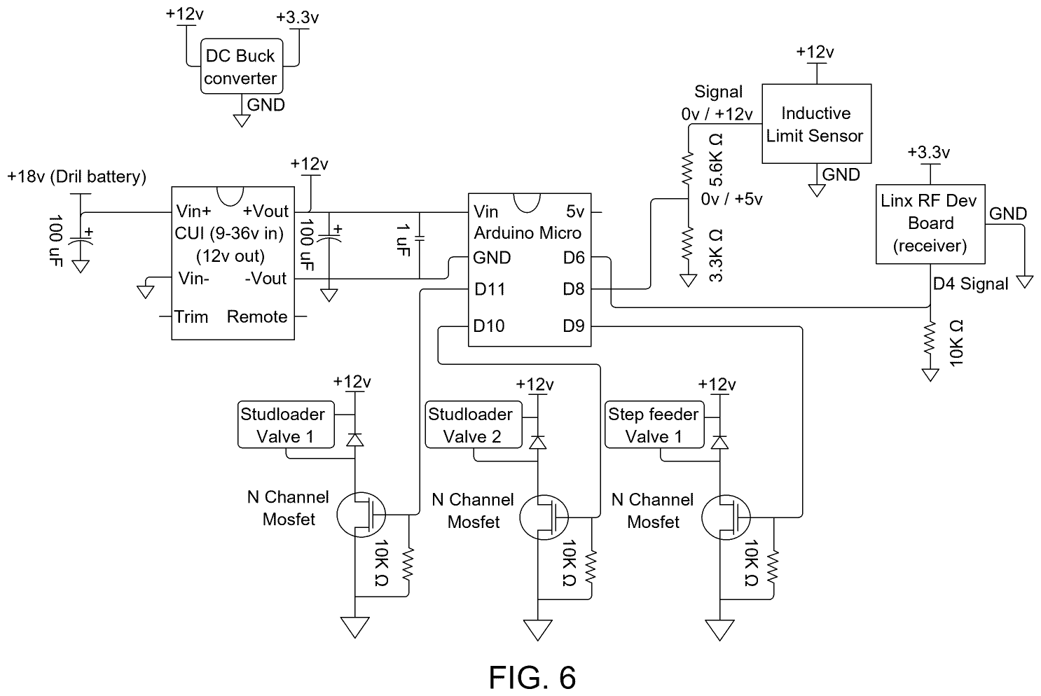

Referring now to FIG. 6, there is shown a schematic diagram illustrating circuitry for operation of the lift mechanism of the inventive apparatus according to an implementation. The control circuitry may include an Arduino microcontroller or any other suitable controller. The controller may selectively operate individual solenoid valves during the stud sorting and loading process. The controller may selectively initiate advancement of the individual shear studs into the gate assembly. The controller may also be utilized to activate a hammer mechanism or other mechanism that imparts a force to a lower end of the shear stud to force the shear stud up into the collet of the welding gun.

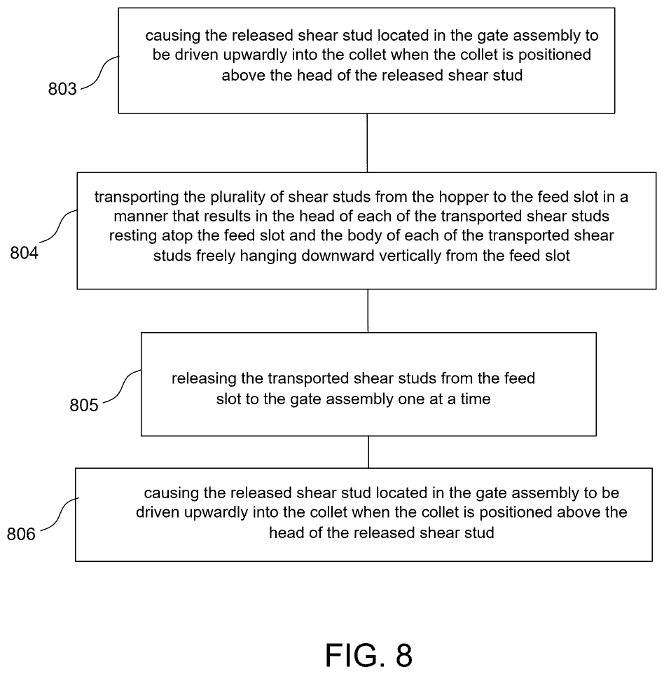

Referring now to FIG. 8, a flowchart is provided showing exemplary functional steps involved in the operation of the illustrative implementation of a shear stud feeder 10 described above. In one implementation, the apparatus and implementations thereof described herein is utilized with a method for sequentially loading a plurality of shear studs into a stud welding gun having a collet. As described herein, each of the plurality of shear studs may include a head attached to a body. The head includes a head diameter and the body is cylindrical in shape and includes a body diameter, with the head diameter being greater than the body diameter. The method may be utilized with a stud loader system that includes a hopper adapted to hold a plurality of shear studs that are randomly oriented, a feed slot having a feed slot width that is greater than the body diameter and less than the head diameter, the feed slot being angled downwardly from an upper end to the lower end, and a gate assembly located at the lower end of the feed slot that is adapted to releasably retain one of the plurality of shear studs at a time and to enable the collet to engage the retained shear stud when the collet is placed above the head of the retained shear stud. The method may include causing 803 the released shear stud located in the gate assembly to be driven upwardly into the collet when the collet is positioned above the head of the released shear stud. The method may further include transporting 804 the plurality of shear studs from the hopper to the feed slot in a manner that results in the head of each of the transported shear studs resting atop the feed slot and the body of each of the transported shear studs freely hanging downward vertically from the feed slot. The method may further include releasing 805 the transported shear studs from the feed slot to the gate assembly one at a time.

In another implementation, the method may further include causing 806 the released shear stud located in the gate assembly to be driven upwardly into the collet when the collet is positioned above the head of the released shear stud. In one implementation, the released shear stud located in the gate assembly is driven upwardly into the collet using a retractable hammer. In another implementation, the released shear stud located in the gate assembly is driven upwardly into the collet when the collet is positioned above the head of the released shear stud in response to a user-activated switch.

All examples and conditional language recited herein are intended for pedagogical purposes to aid the reader in understanding the principles of the present invention and the concepts contributed by the inventor in furthering the art. As such, they are to be construed as being without limitation to such specifically recited examples and conditions. Moreover, all statements herein reciting principles, aspects, and implementations of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It is to be understood that the implementations described herein are merely exemplary and that a person skilled in the art may make many variations and modifications without departing from the spirit and scope of the invention. All such variations and modifications are intended to be included within the scope of the invention, as defined by the following claims.

1. A method for sequentially loading a plurality of shear studs into a stud welding gun having a collet, each of the plurality of shear studs having a head attached to a body, the head having a head diameter and the body being cylindrical in shape and having a body diameter, the head diameter being greater than the body diameter, the method comprising:
(a) providing a hopper adapted to hold a plurality of shear studs that are randomly oriented;
(b) providing a feed slot having a feed slot width that is greater than the body diameter and less than the head diameter, the feed slot being angled downwardly from an upper end to a lower end;
(c) providing a gate assembly located at the lower end of the feed slot that is adapted to releasably retain one of the plurality of shear studs at a time and to enable the collet to engage the retained shear stud when the collet is placed above the head of the retained shear stud;
(d) transporting the plurality of shear studs from the hopper to the feed slot in a manner that results in the head of each of the transported shear studs resting atop the feed slot and the body of each of the transported shear studs freely hanging downward vertically from the feed slot; and
(e) releasing the transported shear studs from the feed slot to the gate assembly one at a time.

2. The method of claim 1, further comprising:
(f) causing the released shear stud located in the gate assembly to be driven upwardly into the collet when the collet is positioned above the head of the released shear stud.

3. The method of claim 2, further comprising performing step (f) using a retractable hammer that drives the shear stud upwardly into the collet.

4. The method of claim 2, wherein step (f) comprising causing the released shear stud located in the gate assembly to be driven upwardly into the collet when the collet is positioned above the head of the released shear stud in response to a user-activated switch.

5. A system for sequentially loading a plurality of shear studs into a stud welding gun having a collet, each of the plurality of shear studs having a head attached to a body, the head having a head diameter and the body having a body being cylindrical in shape and having a body diameter, the head diameter being greater than the body diameter, the system comprising:
a magazine comprising a feed slot having a feed slot axis and feed slot width that is greater than the body diameter and less than the head diameter, the feed slot being angled downwardly from an upper end to a lower end;
a gate assembly located at the lower end, the gate assembly being adapted to releasably retain one of the plurality of shear studs at a time and to enable the collet to engage the retained shear stud when the collet is placed above the head of the retained shear stud; and
an advancing mechanism adapted to release the plurality of shear studs from the magazine to the gate assembly.

6. The system of claim 5, further comprising:
a platform to which the magazine, the gate assembly, and the advancing mechanism are mounted; and
a motorized drive assembly adapted to move the platform;
wherein the platform has a platform longitudinal axis is substantially parallel to the feed slot axis.

7. The system of claim 5, further comprising:
a hopper adapted to contain a plurality of shear studs that are randomly oriented; and
a sorting mechanism adapted to transport the plurality of studs to the feed slot and align the transported studs so that the head of each of the transported shear studs rests atop the feed slot and the body each of the transported shear studs hangs downward vertically from the feed slot.

8. The system of claim 7, wherein the sorting mechanism comprises:
a lift mechanism comprising a lower lift member configured to lift the plurality of shear studs from the hopper and deposit the plurality of shear studs on an intermediate landing, and an upper lift member configured to receive the plurality of shear studs from the intermediate landing and deposit the plurality of shear studs on an upper landing; and
an alignment channel arranged downstream of the lift mechanism, the alignment channel configured to receive the plurality of shear studs from the upper landing and orient the plurality of shear studs with the feed slot of the magazine, the alignment channel including a slot configured for the plurality of shear studs to pass therethrough and into the feed slot.

9. The system of claim 8, wherein the lower lift member is movable between a lowered position adjacent a floor of the hopper and a raised position adjacent the intermediate landing, and wherein the upper lift member is movable between a lowered position adjacent the intermediate landing and a raised position adjacent the upper landing.

10. The system of claim 9, additionally comprising a motor, wherein the motor drives movement of the lower lift member and the upper lift member between the lowered and raised positions.

11. The system of claim 10, additionally comprising a first placement surface disposed on the lower lift member and a second placement surface disposed on the upper lift member, wherein the first and second placement surfaces each have an area sufficient for only one or two shear studs to be placed thereon.

12. The system of claim 8, wherein the alignment channel is positioned over the magazine in a common vertical plane.

13. The system of claim 5, wherein the hopper is hingedly connected to the lift mechanism and is tiltable from a horizontal position to an inclined position.

14. The system of claim 5, wherein the gate assembly includes a hammer assembly adapted to, when actuated, drive a shear stud retained in the gate assembly into the collet.

15. The system of claim 14, further comprising a switch that is adapted to be mounted on the stud welding gun and selectively actuate the hammer assembly.
